(19) United States
(12) Patent Application Publication
(10) Pub. No.: US 2021/0181867 A1
(43) Pub. Date: Jun. 17, 2021

(54) DIGITAL PEN ADAPTER SHELLS

(71) Applicant: HEWLETT-PACKARD DEVELOPMENT COMPANY, L.P., Houston, TX (US)

(72) Inventor: Charles J. STANCIL, Houston, TX (US)

(73) Assignee: HEWLETT-PACKARD DEVELOPMENT COMPANY, L.P., Houston, TX (US)

(21) Appl. No.: 16/076,102

(22) PCT Filed: Apr. 10, 2017
(86) PCT No.: PCT/US2017/026849

§ 371 Date: Aug. 7, 2018

(51) Int. Cl. G06F 3/0354; G06F 3/039

(52) U.S. Cl. CPC G06F 3/03545; G06F 3/0393

(57) ABSTRACT

In some examples, a digital pen adapter shell includes a shell housing providing an inner chamber to removably receive an outer body of a digital pen, where the outer body of the digital pen for gripping by a user when the digital pen is used by the user outside the shell housing. The digital pen adapter shell further incudes a retainer inside the shell housing to engage the body of the digital pen, and an opening, at an end portion of the shell housing, through which a writing tip of the digital pen is to pass.

### BACKGROUND

A digital pen includes a writing tip that is engageable on a writing surface to cause a marking to be made in response to the writing tip interacting with the writing surface as a user writes on the writing surface. The marking can appear on the writing surface, or alternatively, the marking can be displayed on a separate display device.

### BRIEF DESCRIPTION OF THE DRAWINGS

Some implementations of the present disclosure are described with respect to the following figures.

FIGS. 1A and 1B illustrate an arrangement including a digital pen adapter shell to removably receive a digital pen, according to some examples.

FIGS. 2A-2C illustrate various digital pen adapter shells having corresponding different form factors, according to various examples.

FIG. 3 is a block diagram of an arrangement including a digital pen adapter shell and a digital pen, according to further examples.

FIG. 4 illustrates a digital pen adapter shell according to some examples.

FIG. 5 illustrates a digital pen according to some examples.

FIG. 6 is a flow diagram of a process of forming a digital pen adapter shell, according to further examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

A digital pen can refer to an electronic input device (also referred to as a “stylus”) to form a marking based on user manipulation of the input device, where the marking that is made has a pattern that corresponds generally to a gesture of the input device caused by the user manipulation. A marking can refer to text entered by a user, a drawing being made by a user, or any other input symbol, character, or pattern.

The digital pen can have an elongated shape and includes a writing tip that is engageable on a writing surface to cause a marking to be made in response to the writing tip interacting with the writing surface as a user writes on the writing surface. The movement of the digital pen by the user forms a gesture that indicates the marking to be made. In some examples, the writing surface can include a display screen, such that as the user uses the digital pen to write on the display screen, corresponding markings are displayed on the display screen. In other examples, the writing surface can include a non-display surface, such as a board, a surface of a table or other furniture, and so forth. As the user uses the digital pen to write on the non-display surface, the interaction between the digital pen and the non-display surface is detected by a computer, and corresponding markings can appear on a display device coupled to the computer, either directly over a cable or indirectly over a network (wired network or wireless network).

In some examples, interaction between a digital pen and a writing surface can refer to a contact-based interaction, where a writing tip of the digital pen makes contact with the writing surface, and any gesture made while the writing tip is in contact with the digital pen is detected to form a marking. In other examples, interaction between a digital pen and a writing surface can refer to a proximity-based interaction, where a gesture made while the digital pen is within a specified proximity of the writing surface (which can include the writing tip being spaced apart from the writing surface but within a specified distance, or the writing tip touching the writing surface) is detected to form a marking.

A digital pen has a specific form factor, which defines an outer profile of an outer body of the digital pen. This outer profile of the outer body of the digital pen is what a user feels when gripping the digital pen during use. In some examples, the form factor of the digital pen corresponds generally to the form factor of traditional ink pens or pencils that makes ink markings on a writing surface such as paper.

Digital pens may be useable in a number of different contexts. For example, a digital pen can be used to write on a writing surface on a table surface, which is analogous to writing using an ink pen or a pencil on a paper. In such a context, the form factor of the digital pen that corresponds generally to the form factor of a traditional ink pen or pencil may be acceptable to a user. However, in other contexts, users may desire or expect that a digital pen have different form factors. For example, when a user is making markings on a whiteboard (such as when presenting at a meeting or conference), the user may desire that the digital pen have a larger form factor that corresponds generally to the form factor of traditional whiteboard markers. As another example, an architect making an architectural drawing may desire that the digital pen have a form factor corresponding generally to architect pencils. As a further example, a child drawing on a writing surface may desire that the digital pen have a form factor corresponding generally to that of crayons.

Owning multiple different digital pens with different form factors may not be economically feasible, since digital pens are generally much more expensive than their analog counterparts (e.g., ink pens, pencils, whiteboard markers, crayons, etc.).

In accordance with some implementations of the present disclosure, digital pen adapter shells are provided, where different adapter shells can have different form factors. Generally, a “form factor” of an adapter shell can refer to any or some combination of the following physical attributes: a length of the adapter shell, a width (e.g., a diameter) of the adapter shell, a weight of the adapter shell, and a center of gravity of the adapter shell. Each adapter shell has a shell housing that provides an inner chamber to removably receive a “fully configured” or “complete” digital pen. A fully configured or complete digital pen can refer to a digital pen having an outer body and elements of the digital pen contained within the outer body, where the outer body can be gripped by a user during use of the digital pen in making markings on a writing surface.

The fully configured or complete digital pen is inserted as a complete unit into the adapter shell, without first removing inner parts of the digital pen and then inserting the removed inner parts into the adapter shell. Removing inner parts from the outer body of the digital pen would result in the digital pen no longer being useable by a user without first returning the inner parts to the digital pen's outer body or another outer body.

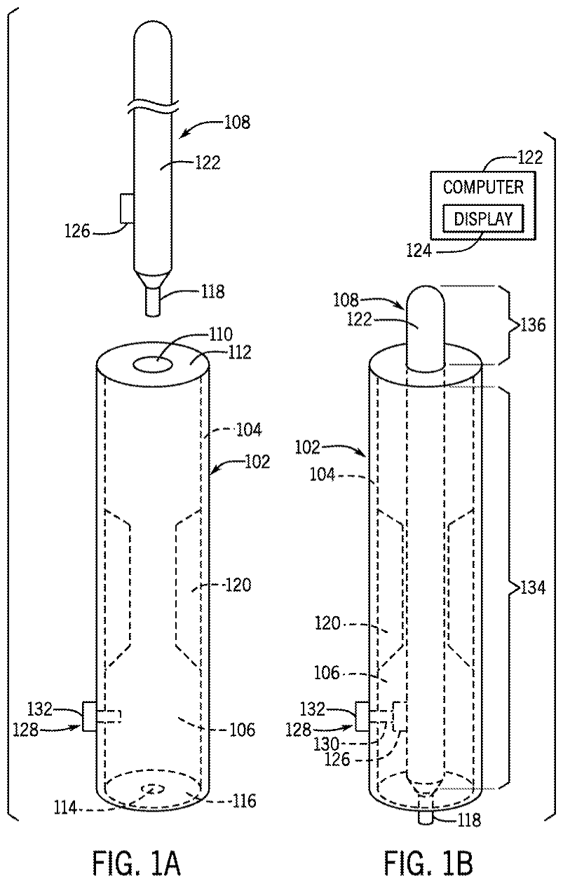

FIGS. 1A-1B illustrate a digital pen adapter shell 102 that has a shell housing 104 that defines an inner chamber 106 to removably receive a digital pen 108. The digital pen 108 is insertable into the inner chamber 106 of the shell housing 104 through an upper opening 110 of the shell housing 104. The upper opening 110 is formed in an upper portion 112 of the shell housing 104.

FIG. 1A further shows a lower opening 114 formed in a lower portion 116 of the shell housing 104. The lower opening 114 is to allow a writing tip 118 of the digital pen 108 to pass through the opening 114, such that the writing tip 118 extends beyond the lower portion 116 of the shell housing 104 and protrudes outwardly from the lower portion 116 of the shell housing 104, as shown in FIG. 1B.

A retainer 120 is provided in the inner chamber 106 of the shell housing 104 to engage an outer surface of an outer body 122 of the digital pen 108. The retainer 120 can include a spring-loaded or compressible protruding structure that can flexibly engage the outer surface of the outer body 122 of the digital pen 108. The retainer 120 is to maintain the digital pen 108 in position once the digital pen 108 has been inserted into the inner chamber 106 of the shell housing 104.

The writing tip 118 is used to engage a writing surface, which can be a display screen or a non-display surface. Interaction of the writing tip 118 with the writing surface can be detected using a sensor assembly, where the sensor assembly can include any or some combination of the following: sensor(s) in the digital pen 108 (where the sensor(s) can detect the movement of the digital pen and pressure applied by the writing tip on the writing surface), sensor(s) that is (are) part of the writing surface (such as a capacitive touch sensor, an optical sensor, etc.), or sensor(s) of a computer (that is (are) able to detect, such as optically, movement and a depth of the digital pen).

In some examples, as shown in FIG. 1B, a computer 122 is able to communicate with the digital pen 108 over a communication medium, where the communication medium can include a wireless medium (e.g., radio frequency or RF medium, infrared medium, etc.) or a wired medium. The computer 122 can include a desktop computer, a notebook computer, a tablet computer, a smartphone, a wearable electronic device (e.g., a smart watch, smart eyeglasses, head-mounted device, etc.), an appliance, a set-top box, and so forth.

In examples where the digital pen 108 includes a sensor (or multiple sensors), the sensor(s) can provide measurement data to the computer 122 regarding movements of the digital pen 108 and/or regarding pressure between the writing tip 118 and a writing surface. In other examples, where the writing surface includes a sensor (or multiple sensors), the sensor(s) on the writing surface can provide measurement data to the computer 122 regarding a gesture made by the digital pen 108. In further examples, the computer 122 can include or be connected to a sensor (or multiple sensors) that is (are) able to detect a gesture of the digital pen 108 on the writing surface.

The computer 122 includes a display screen 124, which can be used to display markings formed in response to gestures of the digital pen 108 made on a writing surface (based on either contact-based interaction or proximity-based interaction). In some examples, the display screen 124 of the computer 122 can be the writing surface with which the writing tip 118 of the digital pen 108 can interact. For example, the computer 122 can be a tablet computer, a smartphone, or any other electronic device that has a display screen that provides a writing surface for the digital pen 108. In other examples, the display screen 124 of the computer 122 is separate from the writing surface for the digital pen 108.

in some examples, the digital pen 108 can include a control button 126. The control button 126 can be used to perform various tasks of the digital pen 108. Although just one control button 126 is shown in FIGS. 1A and 1B, it is noted that in further examples, the digital pen 108 can include multiple control buttons. In some examples, the control button 126 can perform any or some combination of the following tasks: power on/off (the control button 126 when actuated causes the digital pen 108 to be powered on or off), erase (the control button 126 when actuated causes an erase task to be performed, to erase a marking that was previously made), or any other task.

After the digital pen 108 is inserted into the inner chamber 106 of the shell housing 104, the control button 126 may no longer be accessible to a user. To address this issue, the shell housing 104 can be provided with a control button activator 128, which can engage the control button 126 once the digital pen 108 is inserted into the inner chamber 106 of the shell housing 104. The control button activator 128 can include a plunger 130 and a user-actuatable button 132 that can be pressed by the user to cause the plunger 130 to engage the control button 126 of the digital pen 108, to actuate the control button 126. In other examples, instead of using the control button activator 128, an opening can be cut into the side of the shell housing 104, such that the control button 126 can be accessible by the user through this opening to allow the user to actuate the control button 126.

As shown in FIG. 1B, in some examples, when the digital pen 108 is inserted into the inner chamber 106 of the shell housing 104, a first portion 134 of the digital pen 108 is provided inside the shell housing 104, while a second portion 136 of the digital pen 108 remains outside of the shell housing 104 (in other words, the second portion 136 of the digital pen 108 remains exposed even though the first portion 134 of the digital pen 108 is received inside the shell housing 104). The exposed second portion 136 can include the writing tip 118 that extends through the lower opening 114 of the shell housing 104.

Although not shown, in further examples, the digital pen 108 can include an erase element provided on a tail end of the digital pen 108, such as at the top of the portion 136 shown in FIG. 1B. A user can flip the digital pen 108 and engage the erase element on the tail end of the digital pen 108 with the writing surface to digitally erase markings.

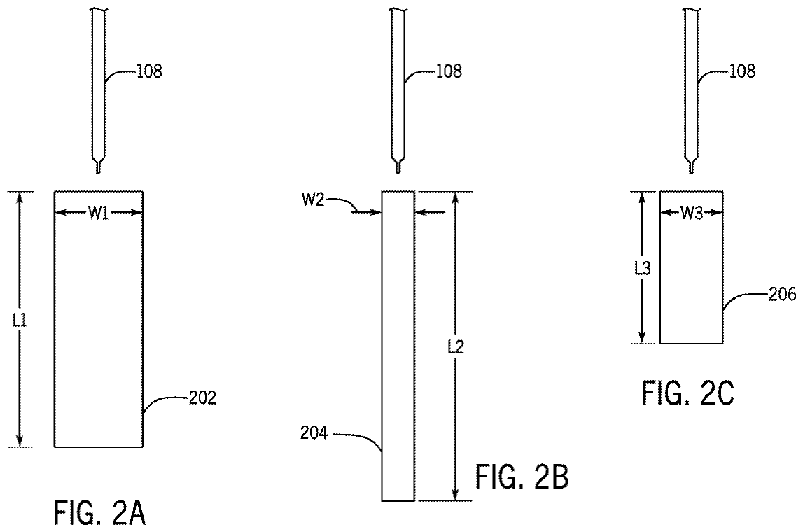

FIGS. 2A-2C show digital pen adapter shells 202, 204, and 206 of different form factors. Each of the digital pen adapter shells 202, 204, and 206 can removably receive the digital pen 108. Thus, for example, a user can purchase the three digital pen adapter shells 202, 204, and 206 of the different form factors, and can selectively insert the digital pen 108 into one of the adapter shells 202, 204, and 206 depending upon the context in which the user wishes to use the digital pen 108. For example, the adapter shell 204 of FIG. 2B can be used in a context where the user is using the digital pen 108 to write onto a generally horizontal writing surface. As another example, the user can use the adapter shell 202 of FIG. 2A when the user is using the digital pen 108 as a marker on a whiteboard writing surface. The adapter shell 206 can have the form factor of a crayon, and the digital pen 108 can be used in the adapter shell 206 when a child is using the digital pen 108 as a crayon.

The adapter shell 202 of FIG. 2A has a width W1 (e.g., a first diameter) and a length L1. The adapter shell 204 of FIG. 28 has a width W2 (e.g., a second diameter) and a length L2, where the width W2 can be different from the width W1, and/or the length L2 can be different from the length L1.

The adapter shell 206 of FIG. 2C has a width W3 (e.g., a third diameter) and a length L3, where W3 can be different from W1 and/or W2, and/or the length L3 can be different from L1 and/or L2.

Although FIGS. 2A-2C show three example form factors, it is noted that in other examples, adapter shells of other different form factors can be provided.

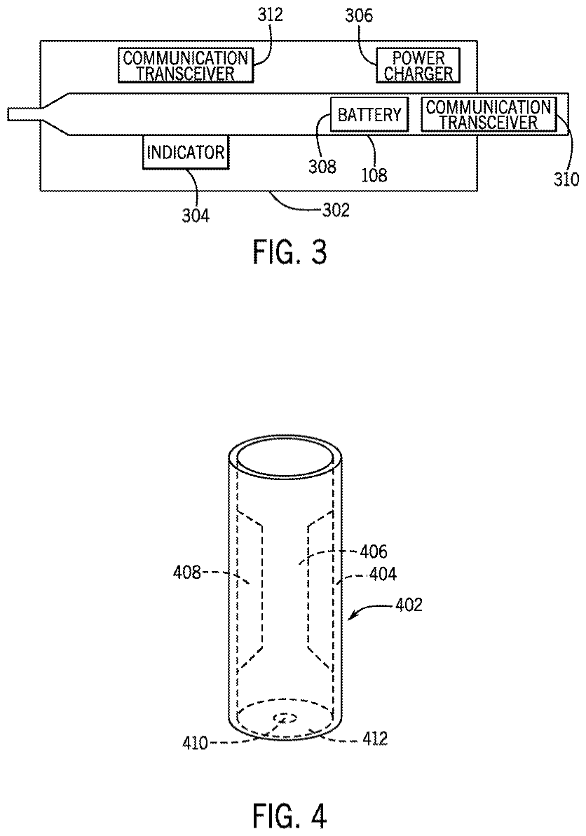

FIG. 3 shows an example adapter shell 302 for removably receiving the digital pen 108, where the adapter shell 302 has an indicator 304 to indicate the type of the adapter shell 302. For example, the adapter shells 202, 204, and 206 shown in FIGS. 2A-2C, respectively, can have different indicators to indicate the respective different types of adapter shells. The indicator 304 can provide a type indication of a writing style for the digital pen 108 that is inserted into the adapter shell 302. The writing style for the digital pen 108 can refer to a characteristic of a marking that is made responsive to a gesture of the digital pen 108. For example, the marking that is made by the digital pen 108 when used with the adapter shell 202 of FIG. 2A can be thicker than a marking made by the digital pen 108 when used with the adapter shell 204 of FIG. 2B. Generally, in some examples, the writing style can specify a characteristic that includes any one or some combination of the following: a thickness of a marking made in response to a gesture of the digital pen 108 (where the thickness can refer to a line width of the marking), a darkness of the marking that is made (e.g., a marking made by the digital pen 108 when used with an adapter shell corresponding to a whiteboard marker is darker than a marking made by the digital pen 108 when used with an adapter shell for an architect's pencil), a color (e.g., a marking made by the digital pen 108 when used with an ink pen adapter shell can produce a black or blue color, whereas a marking made with the digital pen 108 used with a crayon adapter shell can produce a different color, such as yellow, pink, etc.), or any other characteristic of a marking made in response to the writing tip of the digital pen interacting with a writing surface.

The indicator 302 can be a mechanical indicator, which can be detected by the digital pen 108 when the digital pen 108 is inserted into the adapter shell 302 and engages the mechanical indicator 304. The mechanical indicators used in different adapter shells can have different physical profiles, such that the digital pen 108 can detect the different physical profiles of the different mechanical indicators to determine the type of adapter shell into which the digital pen 108 has been inserted. For example, a first mechanical indicator can include a first physical profile that has a first number of protrusions or grooves, a second mechanical indicator can include a second physical profile that has a different second number of protrusions or grooves, and so forth. In other examples, other mechanical indicators can be used.

In other examples, the indicator 304 can be an electronic indicator, which can electronically communicate with the digital pen 108 or with a computer (e.g., the computer 122 of FIG. 1B) to indicate the type of adapter shell 302 into which the digital pen 108 has been inserted. For example, the electronic indicator 304 can include a communication transceiver, such as a wireless transceiver, to transmit the type indication to the digital pen 108 and/or the computer 122. The wireless transceiver can include a Bluetooth transceiver, a Near Field Communication (NFC) transceiver, an RF identification (RFID) transceiver, or any other type of wireless transceiver.

Alternatively, the electronic indicator 304 can make electrical contact with a corresponding contact pad of the digital pen 108 when the digital pen 108 is inserted into the adapter shell 302. The electrical contact between the electronic indicator 304 and the digital pen 108 can allow the digital pen 108 to read an electronic indication of the electronic indicator 304, where the electronic indication can include a value stored in a memory of the electronic indicator 304, or a voltage or current value provided by an analog circuit of the electronic indicator 304.

As further shown in FIG. 3, the adapter shell 302 can include a power charger 306, which can be used to charge a battery 308 in the digital pen 108 after the digital pen 108 is inserted into the adapter shell 302. For example, the power charger 306 can include an inductive coupling coil to inductively couple power to the battery 308 to charge the battery 308. As another example, the power charger 306 can include an electrical contact to make electrical connection with the digital pen 108 after the digital pen 108 is inserted into the adapter shell 302, where the electrical connection allows the power charger 306 to charge the battery 308.

In some examples, the digital pen 108 can include a communication transceiver 310 (a wireless transceiver or a wired transceiver) to communicate with the computer 122 (FIG. 1B) or a communication transceiver 312 of the adapter shell 302. The communication transceiver 312 of the adapter shell 302 can also communicate with the compute 122 in further examples. In other examples, any of the communication transceiver 312, the power charger 306, and the communication transceiver 310 can be omitted.

FIG. 4 shows a simplified view of a digital pen adapter shell 402, which has a shell housing 404 that provides an inner chamber 406 to removably receive an outer body of a digital pen, such as the digital pen 108 shown in FIGS. 1A and 1B.

The adapter shell 402 further includes a retainer 408 inside the shell housing 404 to engage the body of the digital pen 108 after the digital pen is inserted into the inner chamber 406 of the adapter shell 404.

The adapter shell 404 further includes an opening 410 in an end portion 412 of the shell housing 404 through which a writing tip of the digital pen is to pass.

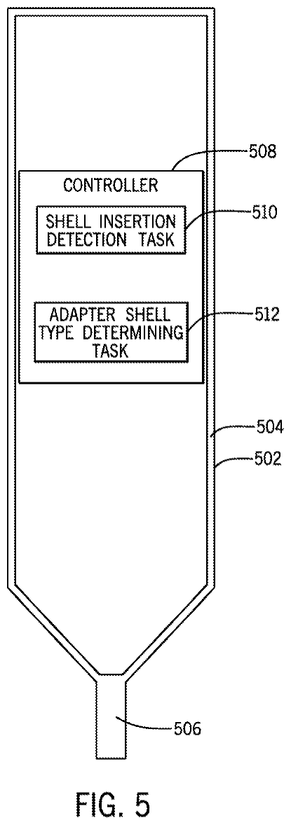

FIG. 5 is a schematic diagram of a digital pen 502 that includes an outer body 504, where the outer body 504 is for holding and gripping by a user when the digital pen 502 is used by a user outside an adapter shell. The digital pen 502 includes a writing tip 506.

The digital pen 502 also includes a controller 508 to perform various tasks. A “controller” as used herein can refer to any hardware processing circuit, which can include logic circuitry, a microprocessor, a core of a multi-core microprocessor, a microcontroller, a programmable gate array, a programmable integrated circuit device, or any other hardware processing circuit. In further examples, a controller can include a combination of a hardware processing circuit and machine-readable instructions (software or firmware) executable on the hardware processing circuit.

The tasks performed by the controller 508 (whether performed by the hardware processing circuit or under control of machine-readable instructions) include a shell insertion detection task 510 to detect insertion of the digital pen 502 into an adapter shell, such as any of the adapter shells discussed above. Another task of the controller 508 is an adapter shell type determining task 512, which determines a type of the adapter shell based on an indicator (e.g., indicator 304 of FIG. 3) of the adapter shell. The controller 508 can transmit, to a computer using a communication transceiver, a writing style indication in response to the determined type of the adapter shell based on the indicator of the adapter shell.

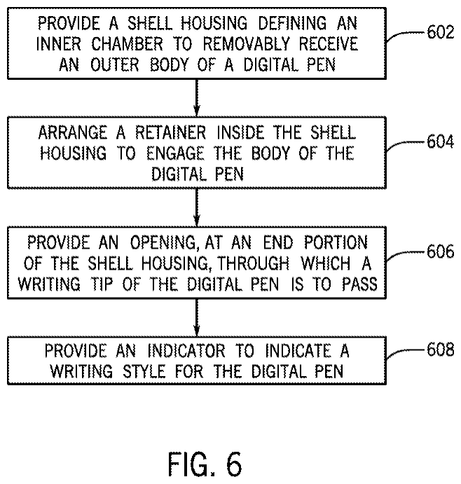

FIG. 6 is a flow diagram of a process of forming a digital pen adapter shell, according to some examples. The method includes providing (at 602) a shell housing defining an inner chamber to removably receive an outer body of a digital pen. The outer body of the digital pen for gripping by a user when the digital pen is used by the user outside the shell housing.

The process further includes arranging (at 604) a retainer inside the shell housing to engage the body of the digital pen.

In addition, the process includes providing (at 606) an opening, at an end portion of the shell housing, through which a writing tip of the digital pen is to pass. The process further incudes providing (at 608) an indicator to indicate a writing style for the digital pen, the indicated writing style controlling a characteristic of a marking made in response to the writing tip of the digital pen interacting with a writing surface.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A digital pen adapter shell comprising:
a shell housing providing an inner chamber to removably receive an outer body of a digital pen, the outer body of the digital pen for gripping by a user when the digital pen is used by the user outside the shell housing;
a retainer inside the shell housing to engage the body of the digital pen; and
an opening, at an end portion of the shell housing, through which a writing tip of the digital pen is to pass.

2. The digital pen adapter shell of claim of claim 1, further comprising:
an indicator to provide a type indication of a writing style for the digital pen.

3. The digital pen adapter shell of claim 2, wherein the type indication controls a characteristic of a marking made in response to the writing tip of the digital pen interacting with a writing surface.

4. The digital pen adapter shell of claim 2, wherein the characteristic controlled by the type indication is selected from among a thickness of the marking, a darkness of the marking, and a color of the marking.

5. The digital pen adapter shell of claim 2, wherein the indicator is detectable by the digital pen after insertion into the inner chamber of the shell housing.

6. The digital pen adapter shell of claim 2, wherein the indicator comprises a communication transceiver to transmit, to a computer, the type indication.

7. The digital pen adapter shell of claim 1, further comprising a power charger to charge a battery of the digital pen once the digital pen is positioned inside the shell housing.

8. The digital pen adapter shell of claim 1, further comprising a control button activator arranged on the shell housing, the control button activator to operatively engage a control button of the digital pen once the digital pen is inserted into the inner chamber of the shell housing.

9. A digital pen comprising:
an outer body;
a writing tip; and
a controller to:
detect insertion of the digital pen into an adapter shell, and
determine a type of the adapter shell based on an indicator of the adapter shell.

10. The digital pen of claim 9, further comprising:
a communication transceiver inside the outer body,
wherein the controller is to transmit, to a computer using the communication transceiver, a writing style indication in response to the determined type of the adapter shell based on the indicator of the adapter shell.

11. The digital pen of claim 9, wherein the adapter shell is a first adapter shell, and the controller is to:
determine a first type of the adapter shell based on the indicator of the first adapter shell,
transmit, to a computer, a first writing style indication in response to the determined first type of the first adapter shell,
detect insertion of the digital pen into a second adapter shell,
determine a second type of the second adapter shell based on an indicator of the second adapter shell, and
transmit, to the computer, a second writing style indication in response to the determined second type of the second adapter shell.

12. The digital pen of claim 11, wherein the first writing style indication is to cause a marking made in response to the writing tip of the digital pen interacting with a writing surface to have a first characteristic, and the second writing style indication is to cause a marking made in response to the writing tip of the digital pen interacting with the writing surface to have a second characteristic different from the first characteristic.

13. The digital pen of claim 11, wherein the first adapter shell has a form factor that differs from a form factor of the second adapter shell.

14. A method of forming a digital pen adapter shell, comprising:
providing a shell housing defining an inner chamber to removably receive an outer body of a digital pen, the outer body of the digital pen for gripping by a user when the digital pen is used by the user outside the shell housing;
arranging a retainer inside the shell housing to engage the body of the digital pen;
providing an opening, at an end portion of the shell housing, through which a writing tip of the digital pen is to pass; and
providing an indicator to indicate a writing style for the digital pen, the indicated writing style controlling a characteristic of a marking made in response to the writing tip of the digital pen interacting with a writing surface.

15. The method of claim 14, wherein the inner chamber of the shell housing is to receive a first portion of the digital pen, while a second portion of the digital pen is exposed and outside the shell housing.
